(19) United States
(12) Patent Application Publication
(10) Pub. No.: US 2020/0223234 A1
(43) Pub. Date: Jul. 16, 2020

(54) RECORDING APPARATUS

(71) Applicant: SEIKO EPSON CORPORATION, Tokyo (JP)

(72) Inventors: Tatsuya SHIRANE, Shiojiri-shi (JP); Narihiro OKI, Matsumoto-shi (JP); Atsuhiko TAKEUCHI, Matsumoto-shi (JP); Hitoshi IGARASHI, Shiojiri-shi (JP); Junki AKAMA, Shiojiri-shi (JP); Sho ARUGA, Chino-shi (JP)

(21) Appl. No.: 16/822,977

(22) Filed: Mar. 18, 2020

Related U.S. Application Data
(62) Division of application No. 15/722,721, filed on Oct. 2, 2017.

(30) Foreign Application Priority Data
Oct. 5, 2016 (JP) 2016-197375
Nov. 28, 2016 (JP) 2016-230082
Jun. 13, 2017 (JP) 2017-116125

(51) Int. Cl. B41J 11/00; B41J 2/01; B41J 13/00; B65H 9/00; B65H 7/08

(52) U.S. Cl. CPC B41J 11/0055; B41J 2/01; B41J 13/0027; B65H 9/008; B65H 2513/51; B65H 7/08; B65H 2511/415; B65H 2511/10; B65H 2513/41; B65H 9/00

(57) ABSTRACT

A recording apparatus is provided with a transport roller pair which transports a medium toward a recorder, a feed roller which transports the medium toward the transport roller pair, and a controller which controls the transport roller pair and the feed roller. The controller is capable of executing a combined skew rectification mode which executes one of a first skew rectification operation in which a leading end of the medium abuts the transport roller pair using backward rotation of the transport roller pair and forward rotation of the feed roller and a second skew rectification operation in which the transport roller pair to rotate backward without driving the feed roller and discharges the leading end of the medium to the upstream side of the transport roller pair, and subsequently executes the other of the skew rectification operations.

### BACKGROUND

### 1. Technical Field

The present invention relates to a recording apparatus which performs recording on a medium.

### 2. Related Art

In a recording apparatus represented by an ink jet printer, a technique of rectifying oblique motion (skewing) of a sheet of paper which is fed out by a feed roller from a paper housing portion such as a paper feeding cassette using a resist roller pair in front of a recording head is adopted in the related art.

As skew rectification methods, there are mainly two types, one of which is, as illustrated in JP-A-2016-078388, a system in which a paper leading end is caused to abut a resist roller pair which is rotating backward and the paper leading end is caused to conform to a nipping position of the resist roller pair (hereinafter referred to as “the backward rotating abutting system”).

The other is, as illustrated in JP-A-2013-129506, a system in which the paper leading end is allowed to be taken into the resist roller pair by a predetermined amount, the resist roller pair is subsequently rotated backward to discharge the paper leading end to the upstream side of the resist roller pair, and the paper leading end is caused to conform to the nipping position of the resist roller pair (hereinafter referred to as “the take-in discharge system”).

There are merits in that, since the skew rectification of a backward rotating abutting system causes a feed roller which is upstream of a resist roller pair to rotate forward during the skew rectification, the paper rotates easily at the position of the feed roller, and since the paper leading end is actively caused to abut the nipping position of the resist roller pair by the feed roller, the skew rectification effect is high.

However, there is a demerit in that as the size of the apparatus is reduced, the diameter of the resist roller pair becomes small and in this case, the paper leading end is not guided to the nipping position of the resist roller pair but abuts the circumferential surface of the roller on one side which configures the resist roller pair (hereinafter referred to as “abutment of the paper leading end”) and a case arises in which the skew rectification may not be appropriately performed.

In addition, since the feed roller which is upstream of the resist roller pair is caused to rotate forward during the skew rectification, the bending increases when the paper is caused to bend between the resist roller pair and the feed roller which is upstream thereof, and this point is also a barrier to the reduction in the size of the apparatus.

Since the skew rectification of the take-in discharge system does not cause the feed roller of the upstream side of the resist roller pair to rotate during the skew rectification, it is possible to perform the skew rectification in a state in which the bending of the paper between the resist roller pair and the feed roller is suppressed, and the skew rectification of the take-in discharge system is effective in a case in which the size of the apparatus is reduced.

However, there is a demerit in that the force with which the paper leading end is pushed against the nipping position of the resist roller pair is weak in comparison to the skew rectification of the backward rotating abutting system and the effect of the skew rectification is often inferior to that of the backward rotating abutting system.

As described above, in a case in which the apparatus is to be reduced in size, there is a problem in that the skew rectification system of the backward rotating abutting system may not be adopted without change, and if the skew rectification system of the take-in discharge system is adopted without change, there is a case in which sufficient skew rectification may not be performed.

In addition, in a case in which the attachment precision of the feed roller which is provided upstream of the resist roller pair is poor, for example, a rotating shaft center line of the feed roller is not perpendicular to the paper transport direction, there is a case in which the skewing becomes notable, and as a result, the skewing may not be fully rectified even if the skew rectification methods are adopted. In addition, in such a case, since the skewing continues to be formed in accordance with the feeding of the paper at the upstream side of the resist roller pair even if the skew rectification is performed, a lateral difference arises in the bending of the paper upstream of the resist roller pair, which may cause skewing to arise at the downstream side of the resist roller pair.

### SUMMARY

An advantage of some aspects of the invention is to provide a recording apparatus which is capable of performing more appropriate skew rectification while reducing the size of the apparatus.

An advantage of another aspect of the invention is to provide a recording apparatus which is provided with a more appropriate apparatus configuration when performing the skew rectification.

According to an aspect of the invention, there is provided a recording apparatus which includes a recorder which performs recording on a medium, a transport roller pair which is provided upstream of the recorder in a transport path of the medium and transports the medium to a position facing the recorder, a feed roller which feeds the medium toward the transport roller pair, and a controller which controls the transport roller pair and the feed roller, in which the controller is capable of executing a combined skew rectification mode which executes one of a first skew rectification operation in which a leading end of the medium abuts the transport roller pair in accordance with formation of bending in the medium between the feed roller and the transport roller pair using backward rotation of the transport roller pair and forward rotation of the feed roller and a second skew rectification operation in which, after feeding the leading end of the medium to a downstream side by a predetermined amount from a nipping position of the transport roller pair, causes the transport roller pair to rotate backward without driving the feed roller and discharges the leading end of the medium to the upstream side of the transport roller pair, and subsequently executes the other of the skew rectification operations.

According to this aspect, since the controller is capable of executing a combined skew rectification mode which executes one of the first skew rectification operation, that is a skew rectification operation of the backward rotating abutting system, and the second skew rectification operation that is, a skew rectification operation of the take-in discharge system and subsequently executes the other of the skew rectification operations, even if the size of the apparatus is reduced, it is possible to perform appropriate skew rectification.

The combined skew rectification mode may be a mode which executes the first skew rectification operation and subsequently executes the second skew rectification operation.

According to this aspect, since the combined skew rectification mode is a mode in which the second skew rectification operation, that is, the skew rectification operation of the take-in discharge system is performed after executing the first skew rectification operation, that is, the skew rectification operation of the backward rotating abutting system, by first performing the skew rectification operation of the backward rotating abutting system, even if abutment of the medium leading end to the transport roller pair occurs, a certain degree of skew rectification may be anticipated.

Additionally, it is possible to avoid abutment of the medium leading end to the transport roller pair, in the end, to rectify the skewing by subsequently performing the second skew rectification operation, that is, the skew rectification operation of the take-in discharge system, and since a certain degree of skew rectification is performed by the skew rectification operation of the backward rotating abutting system before the skew rectification operation of the take-in discharge system, it is possible to compensate for faults in the skew rectification operation of the take-in discharge system (the effect of the skew rectification being low in comparison to the backward rotating abutting system), and as a result it is possible to appropriately rectify the skewing.

In particular, even if the diameter of the rollers which configure the transport roller pair is reduced in size in accordance with a reduction in the size of the apparatus, it is possible to appropriately rectify the skewing.

The combined skew rectification mode may be a mode which executes the second skew rectification operation and subsequently executes the first skew rectification operation.

According to this aspect, since the combined skew rectification mode is a mode in which the first skew rectification operation, that is, the skew rectification operation of the backward rotating abutting system is performed after executing the second skew rectification operation, that is, the skew rectification operation of the take-in discharge system, by first performing the skew rectification operation of the take-in discharge system, it is possible to avoid the abutment of the medium leading end to the transport roller pair and to cause the medium leading end to appropriately reach the nipping position of the transport roller pair.

Additionally, in a case in which the skew rectification operation of the take-in discharge system is performed only one time to perform the skew rectification, in consideration of oblique motion of the medium leading end, it is necessary to increase the take-in amount in order to reliably cause the paper leading end to be taken into the transport roller pair, and thus, the bending amount after discharging the medium leading end is increased, and there is a case in which a reduction in the size of the apparatus may not be supported.

However, since the skew rectification operation of the take-in discharge system which is executed first in the combined skew rectification mode is a preparatory operation before performing the next skew rectification operation of the backward rotating abutting system, the take-in amount may be little. In other words, even if the apparatus is reduced in size and the space in which the medium is capable of bending is narrow, it is possible to support this configuration.

By subsequently performing the first skew rectification operation, that is, the skew rectification operation of the backward rotating abutting system, it is possible to appropriately rectify the skewing of the medium.

In particular, even if the diameter of the rollers which configure the transport roller pair is reduced in size in accordance with a reduction in the size of the apparatus, it is possible to appropriately rectify the skewing.

The recording apparatus may further include a first setting unit and a second setting unit which are capable of setting the medium, in which the feed roller is a roller which inverts the medium which is fed out from the first setting unit toward the transport roller pair, in which a configuration is provided in which the medium which is fed out from the second setting unit is fed to the transport roller pair without being inverted, and in which the controller does not select the combined skew rectification mode in a case in which the medium is fed from at least the second setting unit.

According to this aspect, in a case in which the medium is fed to the transport roller pair without being inverted, that is, in a case in which the medium is fed in the feed path in which skewing does not occur easily, since the combined skew rectification mode is not selected, it is possible to suppress a reduction in the throughput.

The controller may select the combined skew rectification mode according to a size of the medium.

According to this aspect, since the combined skew rectification mode is selected according to a size of the medium, it is possible to suppress a reduction in throughput by not applying the combined skew rectification mode to a medium of a size in which skewing does not occur easily (for example, a medium of a large size), and it is possible to appropriately rectify the skewing by applying the combined skew rectification mode to a medium of a size in which skewing occurs easily (for example, a medium of a small size).

The controller may select the combined skew rectification mode according to a type of the medium.

According to this aspect, since the combined skew rectification mode is selected according to the type of the medium, for example, it is possible to suppress a reduction in throughput by not applying the combined skew rectification mode to a medium in which abutment of the medium leading end to the transport roller pair does not occur easily, and it is possible to appropriately rectify skewing by applying the combined skew rectification mode to a medium of a type in which abutment of the medium leading end to the transport roller pair occurs easily.

The recording apparatus may further include an inversion path in which, after recording of a first surface of the medium is performed, the medium is fed into the feed roller again and the medium is inverted such that a second surface of an opposite side from the first surface faces the recorder, in which the controller selects the combined skew rectification mode according to the surface of the medium on which to perform the recording.

According to this aspect, since the combined skew rectification mode is selected according to the surface (that is, the first surface or the second surface) of the medium on which to perform the recording, it is possible to suppress a reduction in throughput by not selecting the combined skew rectification mode in a situation in which abutment of the medium leading end to the transport roller pair does not occur easily, and it is possible to appropriately rectify skewing by selecting the combined skew rectification mode in a situation in which abutment of the medium leading end to the transport roller pair occurs easily.

The transport roller pair may be configured to include a first transport roller and a second transport roller which has a relatively low friction coefficient between the second transport roller and the medium as compared to the first transport roller, and the controller may select the combined skew rectification mode when the surface of the medium with a high friction coefficient contacts the first transport roller in a case in which the friction coefficient between one of the surfaces of the first surface and the second surface of the medium and the first transport roller is relatively high as compared to the other surface.

According to this aspect, a similar operational effect to that of the previous aspect may be obtained.

According to another aspect of the invention, a recording apparatus includes a recorder which performs recording on a medium, a transport roller pair which is provided upstream of the recorder in a transport path of the medium and transports the medium to a position facing the recorder, a first roller which feeds the medium toward the transport roller pair, a plurality of second rollers are provided with respect to the width of the first roller and which contact the first roller to be driven to rotate, and an adjustment unit which adjusts an angle which is formed between a rotating shaft center line of the second rollers and a medium transport direction.

According to this aspect, since the adjustment unit which adjusts the angle which is formed between the rotating shaft center line of the second roller and the medium transport direction is provided, hypothetically, even in a case in which the attachment precision of the second roller is poor and the rotating shaft center line is not perpendicular to the medium transport direction, due to the angle which is formed between the rotating shaft center line of the second roller and the medium transport direction being adjusted, the feed direction of the medium is adjusted to a more appropriate direction by the first roller and the second roller and so it is possible to suppress skewing.

The term “the rotating shaft center line of the second roller” means the rotating shaft center line of the second roller itself and not the axial middle line of the rotating shaft of the second roller. In other words, it is assumed that there is a case in which the rotating shaft center line of the second roller itself and the axial middle line of the rotating shaft of the second roller are not parallel.

The second rollers may be provided to be capable of being displaced along an axial line direction of a rotating shaft of the second rollers, and regulating portions which are on both sides of the second rollers in the axial line direction and regulate the displacement of the second rollers in the axial line direction may be provided closer to the upstream side than the rotating shaft in the medium transport direction.

According to this aspect, since the second rollers are provided to be capable of being displaced along an axial line direction of a rotating shaft of the second rollers and regulating portions which are on both sides of the second rollers in the axial line direction and regulate the displacement of the second rollers in the axial line direction are provided closer to the upstream side than the rotating shaft in the medium transport direction, the second rollers are capable of easily oscillating centered on the abutting part between the second rollers and the regulating portions, that is, it is easy to adjust the angle which is formed between the rotating shaft center line of the second rollers and the medium transport direction.

According to still another aspect of the invention, there is provided a recording apparatus which includes a recorder which performs recording on a medium, a transport roller pair which is provided upstream of the recorder in a transport path of the medium and transports the medium to a position facing the recorder, a first roller which feeds the medium toward the transport roller pair, a second roller which contacts the first roller to be driven to rotate, and an adjustment unit which adjusts an angle which is formed between a rotating shaft center line of the second roller and a medium transport direction, in which the second roller is provided to be capable of being displaced along an axial line direction of a rotating shaft of the second roller, and in which regulating portions which are on both sides of the second roller in the axial line direction and regulate the displacement of the second rollers in the axial line direction are provided closer to the upstream side than the rotating shaft in the medium transport direction.

According to this aspect, since the adjustment unit which adjusts the angle which is formed between the rotating shaft center line of the second roller and the medium transport direction is provided, hypothetically, even in a case in which the attachment precision of the second roller is poor and the rotating shaft center line is not perpendicular to the medium transport direction, due to the angle which is formed between the rotating shaft center line of the second roller and the medium transport direction being adjusted, the feed direction of the medium is adjusted to a more appropriate direction by the first roller and the second roller and so it is possible to suppress skewing.

According to this aspect, since the second roller is provided to be capable of being displaced along an axial line direction of a rotating shaft of the second roller and regulating portions which are on both sides of the second roller in the axial line direction and regulate the displacement of the second roller in the axial line direction are provided closer to the upstream side than the rotating shaft in the medium transport direction, the second roller is capable of easily oscillating centered on the abutting part between the second roller and the regulating portions, that is, it is easy to adjust the angle which is formed between the rotating shaft center line of the second roller and the medium transport direction.

A plurality of driven rollers may be provided along a circumferential direction of the first roller, and among the plurality of driven rollers, at least the driven roller which is positioned first on the upstream side of the transport roller pair or the driven roller which is positioned first on the upstream side thereof may be the second roller.

According to this aspect, since a plurality of driven rollers are provided along a circumferential direction of the first roller, and among the plurality of driven rollers, at least the driven roller which is positioned first on the upstream side of the transport roller pair or the driven roller which is positioned first on the upstream side thereof is the second roller, by applying the second roller to the driven rollers which have a great influence on the skew rectification, it is possible to effectively rectify the skewing.

The adjustment unit may be configured to include a convex portion which is provided on the second roller on an inner circumferential portion which contacts a rotating shaft of the second roller, and the second roller may oscillate using a contact portion between the convex portion and the rotating shaft as a fulcrum and an angle between the rotating shaft center line and a medium transport direction may be adjusted.

According to this aspect, since the adjustment unit is configured to include a convex portion which is provided on the second roller on an inner circumferential portion which contacts a rotating shaft of the second roller, and the second roller is configured to oscillate using a contact portion between the convex portion and the rotating shaft as a fulcrum and an angle between the rotating shaft center line and a medium transport direction is adjusted, it is possible to configure the adjustment unit with a simple structure at low cost.

The recording apparatus may further include a jump regulating portion which regulates jumping to the second roller of a medium rear end which deviates from a nipping position between the first roller and the second roller.

When the medium rear end deviates from the nipping position between the first roller and the second roller, since the medium which curves along the outer circumferential surface of the first roller is apt to return to the original state, a phenomenon in which the medium rear end is apt to jump (spring) up from the first roller arises, and there is a concern that at this time the medium transport precision will be disturbed and, as a result, the recording quality will be disturbed.

According to this aspect, since the recording apparatus further includes a jump regulating portion which regulates jumping to the second roller of a medium rear end which deviates from a nipping position between the first roller and the second roller, it is possible to suppress the disturbance to the recording quality.

### BRIEF DESCRIPTION OF THE DRAWINGS

The invention will be described with reference to the accompanying drawings, wherein like numbers reference like elements.

FIG. 1 is an external perspective view of a printer according to the invention.

FIG. 2 is a lateral sectional view illustrating an entirety of a paper transport path of the printer according to the invention.

FIG. 3 is a block diagram illustrating a control system of the printer according to the invention.

FIG. 4 is a partially enlarged view of the paper transport path of the printer according to the invention.

FIG. 5 is a schematic diagram of the paper transport path between an intermediate roller and a transport roller pair.

FIG. 6 is a schematic diagram of the paper transport path between the intermediate roller and the transport roller pair.

FIG. 7 is a schematic diagram of the paper transport path between the intermediate roller and the transport roller pair.

FIG. 8 is a flowchart illustrating the flow of recording operations.

FIG. 9 is a table illustrating a skew rectification method which is set according to a feed path, a paper type, and a paper size.

FIG. 10 is a perspective view of a path member, a roller support member, and a second driven roller.

FIG. 11 is a perspective view of the path member, the roller support member, and the second driven roller.

FIG. 12 is a perspective view of the roller support member and the second driven roller.

FIG. 13 is a perspective view of the roller support member.

FIG. 14 is a perspective view of the second driven roller.

FIG. 15 is a perspective view of the second driven roller.

FIG. 16 is a sectional view of the roller support member and the second driven roller.

FIG. 17 is a sectional view of the roller support member and the second driven roller.

FIG. 18 is a partially enlarged view of the paper transport path of the printer according to the invention.

FIG. 19 is a view of a regulating member which regulates a progression direction of a paper leading end as viewed from a bottom side of an apparatus toward a top side.

FIG. 20 is a partially enlarged view of the paper transport path of the printer according to the invention.

FIG. 21 is a perspective view illustrating another embodiment of a path member and a roller support member.

FIG. 22 is a perspective view illustrating another embodiment of a roller support member.

FIG. 23 is a perspective view illustrating another embodiment of a roller support member.

FIG. 24 is a perspective view illustrating another embodiment of a path member.

FIG. 25 is a partially enlarged view of the paper transport path of the printer according to the invention.

FIG. 26 is a lateral sectional view of a guide member.

### DESCRIPTION OF EXEMPLARY EMBODIMENTS

Hereinafter, a description is given of an embodiment of the invention based on the drawings; however, the invention is not limited to the embodiments described hereinafter, may be modified in various ways within the scope of the invention described in the claims, and hereinafter, an embodiment of the invention is described assuming that such modifications are included within the scope of the invention.

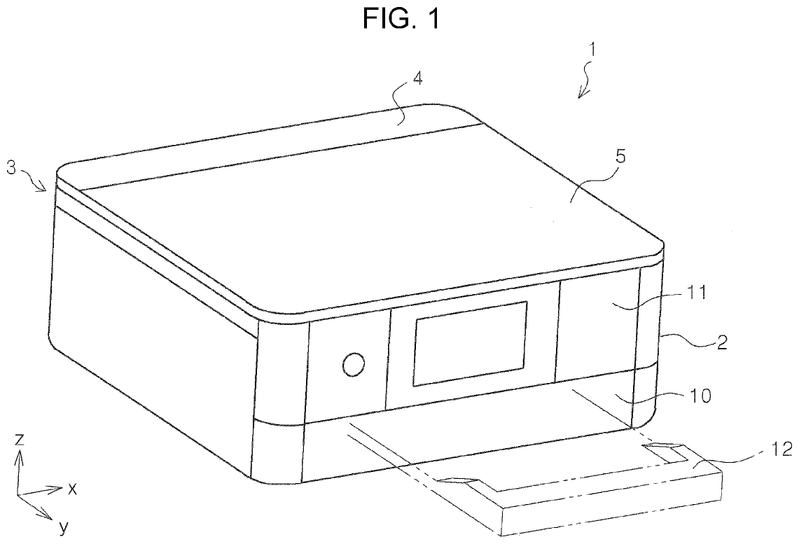

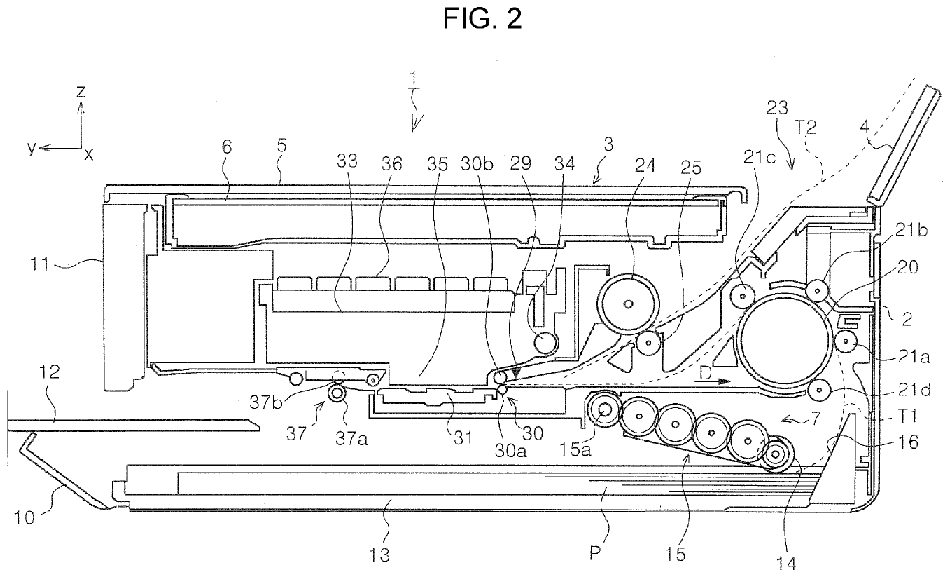

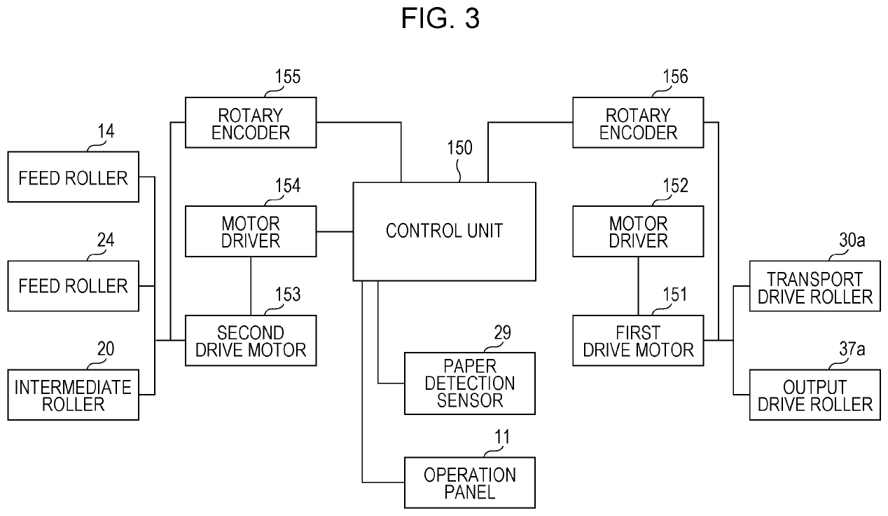

FIG. 1 is an external perspective view of an ink jet printer (hereinafter referred to as a “printer”) 1 which is an embodiment of a “recording apparatus” according to the invention, FIG. 2 is a lateral sectional view illustrating an entirety of a paper transport path of the printer 1, and FIG. 3 is a block diagram illustrating a control system of the printer 1.

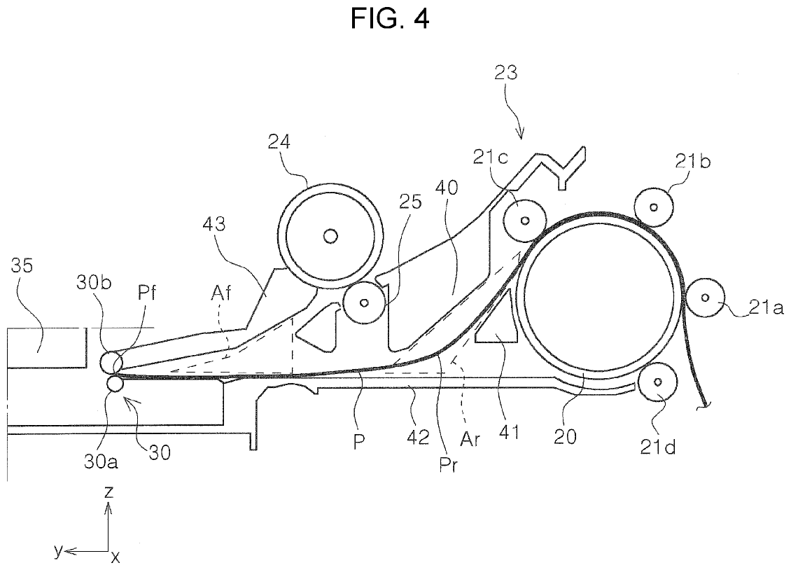

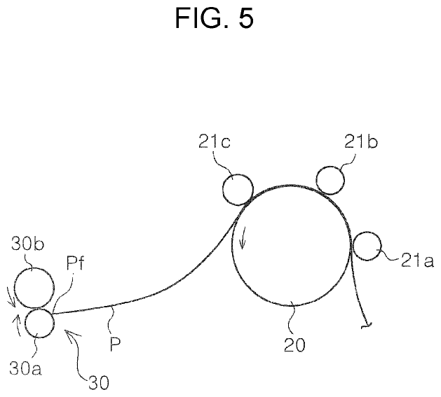

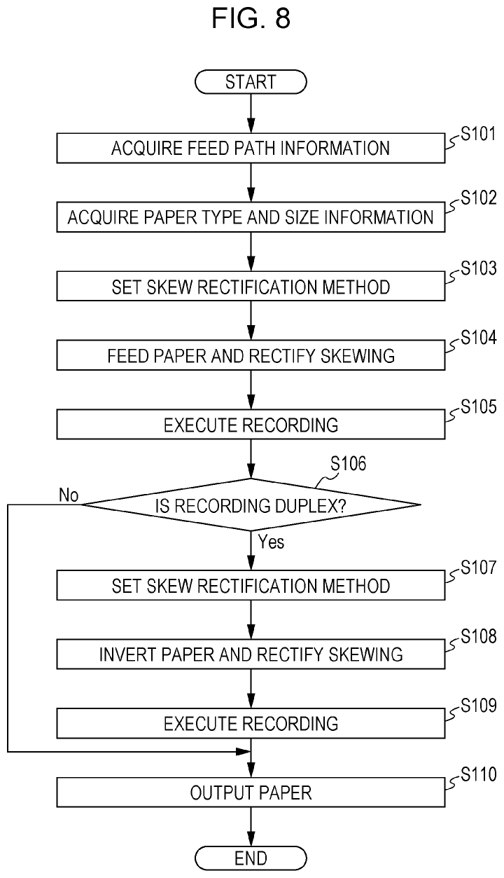

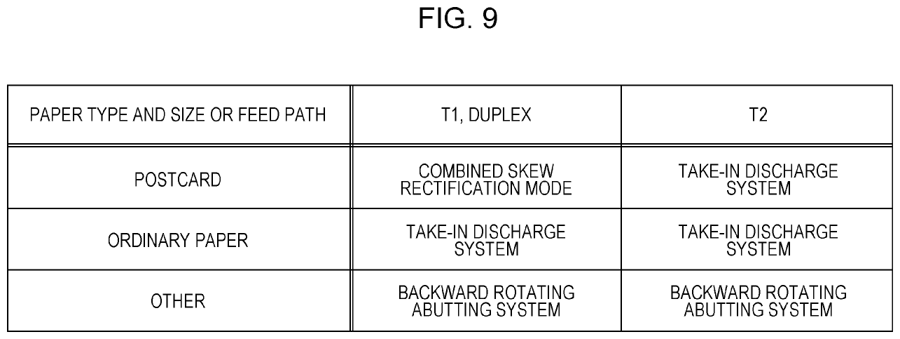

FIG. 4 is a partially enlarged view of the paper transport path of the printer 1, FIGS. 5 to 7 are schematic diagrams of the paper transport path between an intermediate roller 20 and a transport roller pair 30, and FIG. 8 is a flowchart illustrating the flow of recording operations. Furthermore, FIG. 9 is a table illustrating a skew rectification method which is set according to a feed path, a paper type, and a paper size.

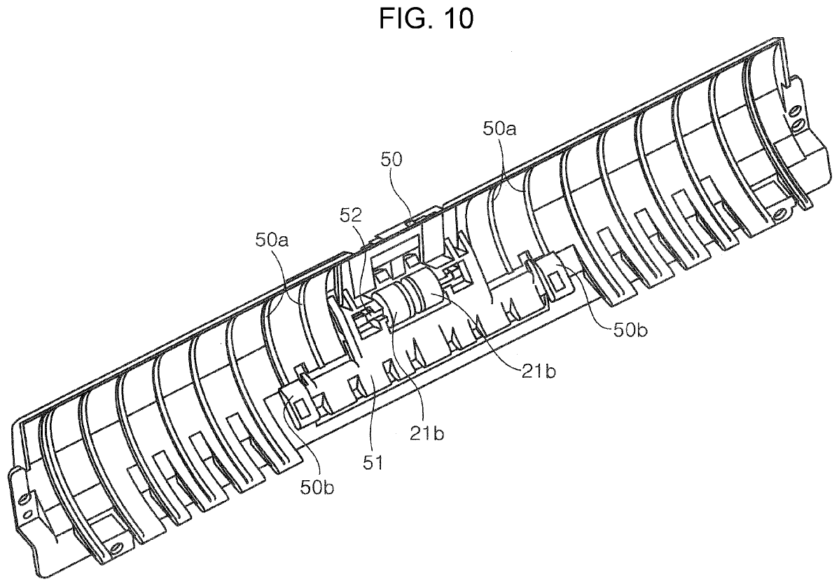

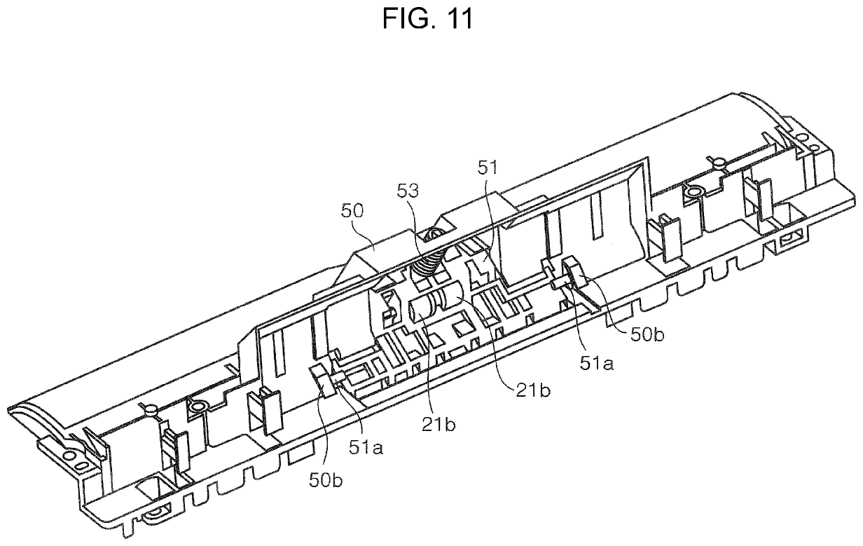

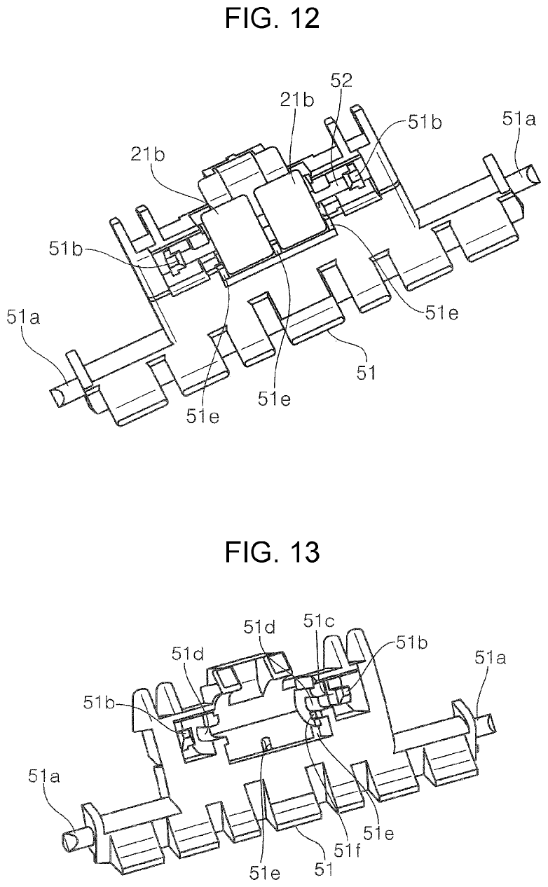

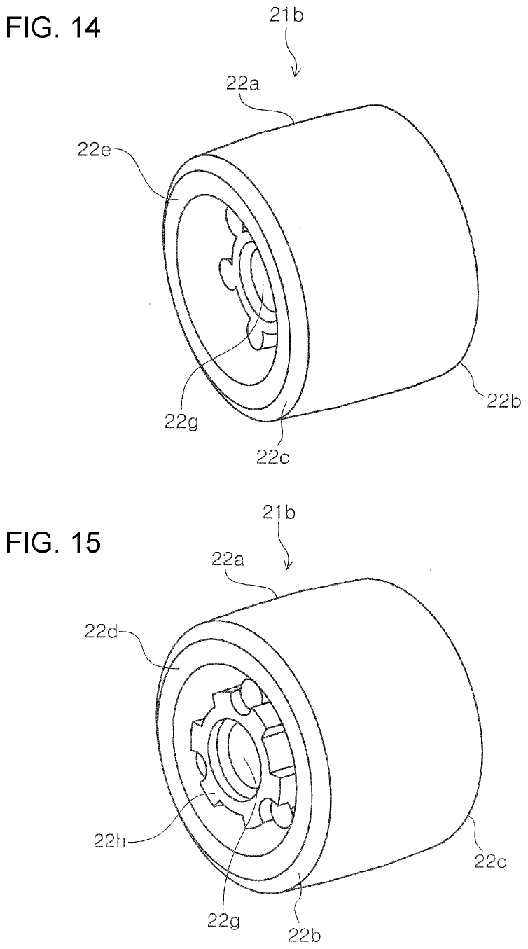

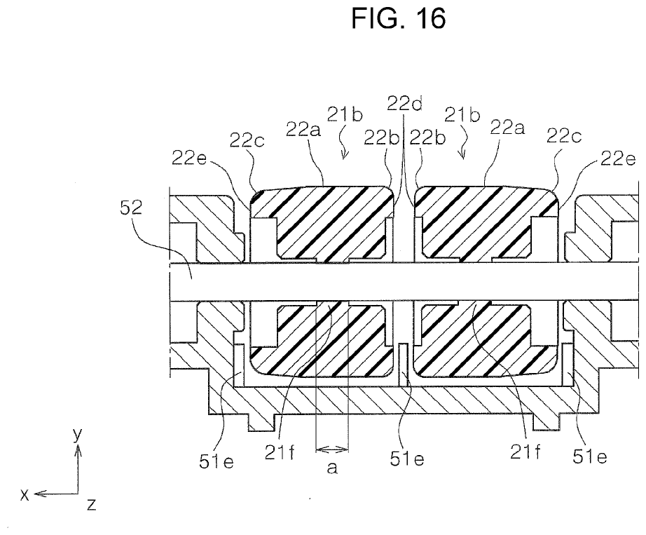

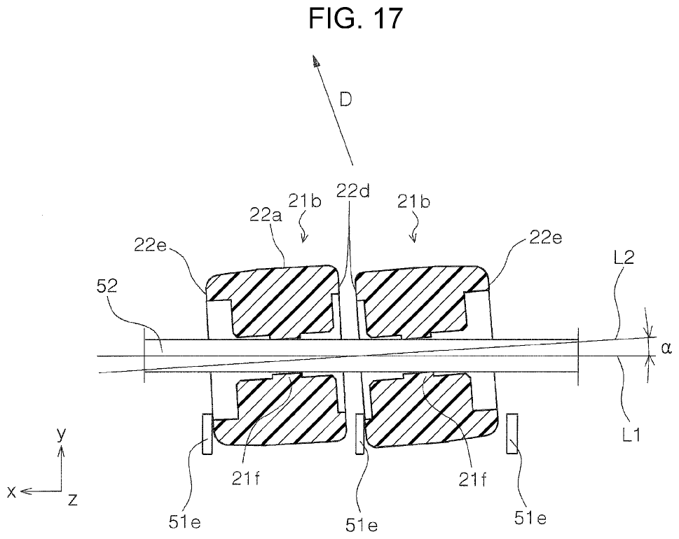

FIGS. 10 and 11 are perspective views of a path member 50, a roller support member 51, and a second driven roller 21b, FIG. 12 is a perspective view of the roller support member 51 and the second driven roller 21b, FIG. 13 is a perspective view of the roller support member 51, FIGS. 14 and 15 are perspective views of the second driven roller 21b, and FIGS. 16 and 17 are sectional views of the roller support member 51 and the second driven roller 21b. In FIG. 17, the hatching (the hatching illustrating a cross-sectional portion) illustrated in FIG. 16 is omitted for the convenience of illustration.

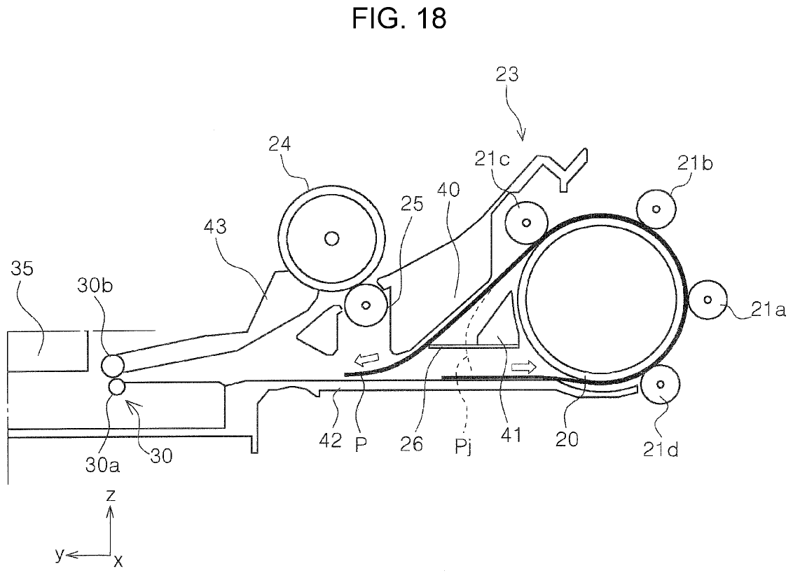

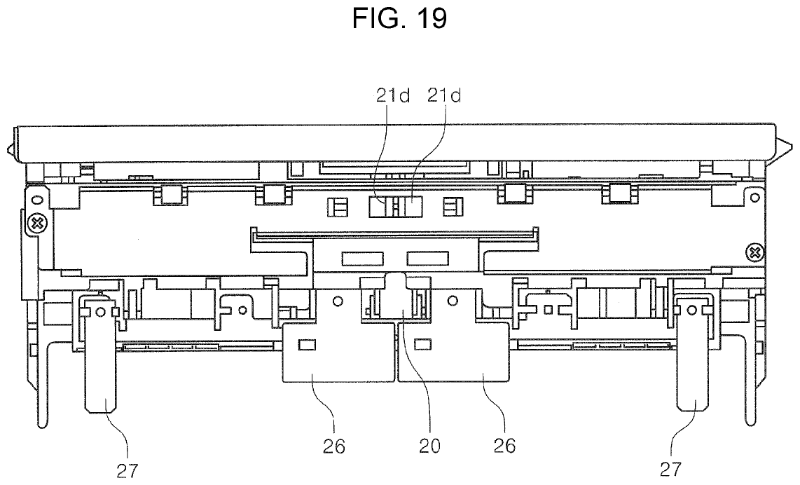

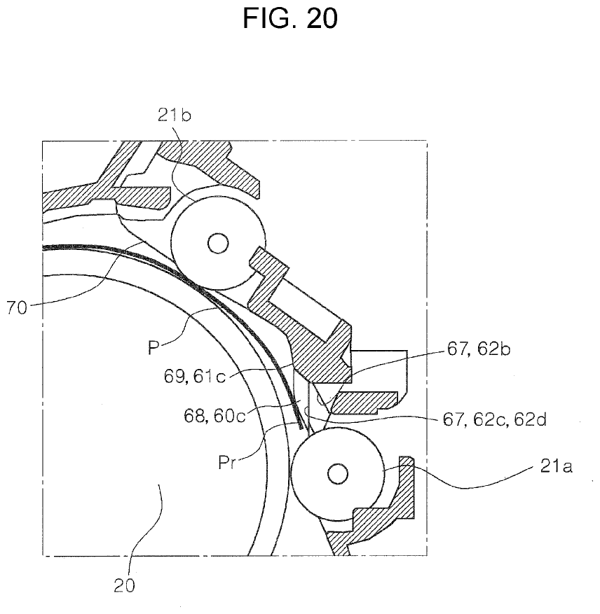

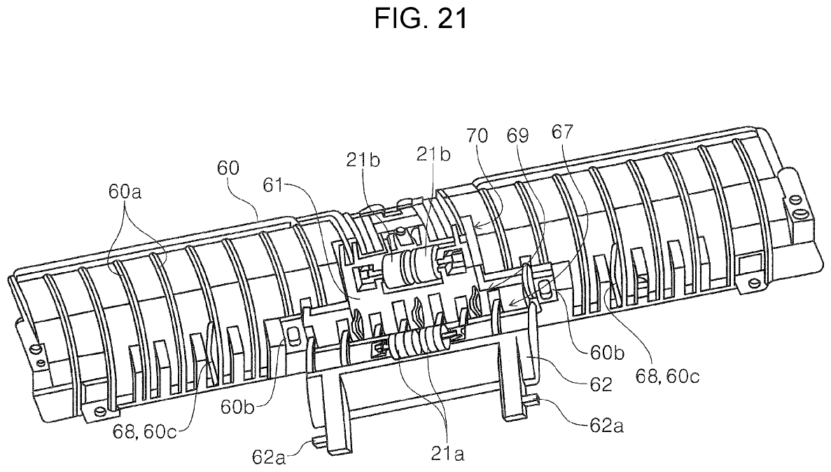

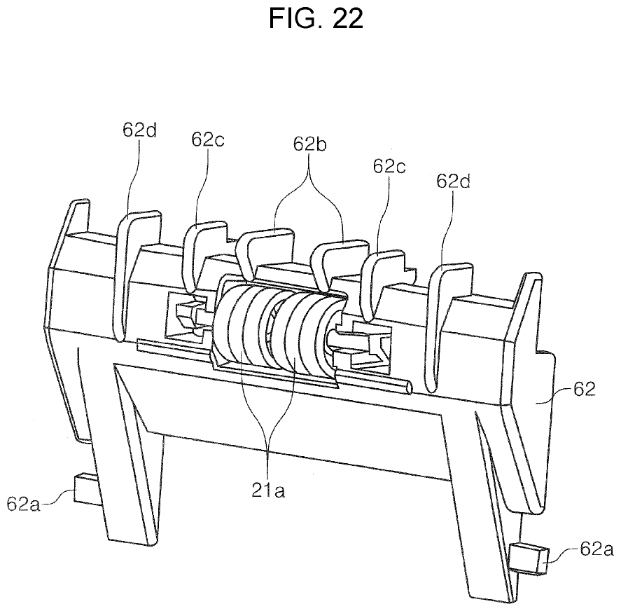

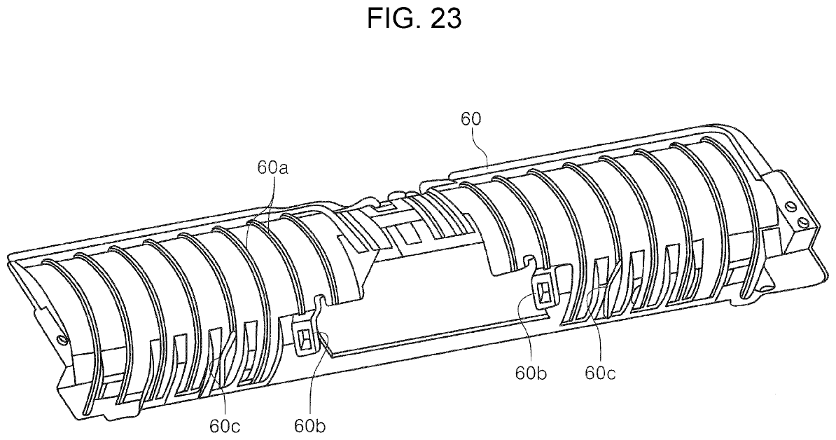

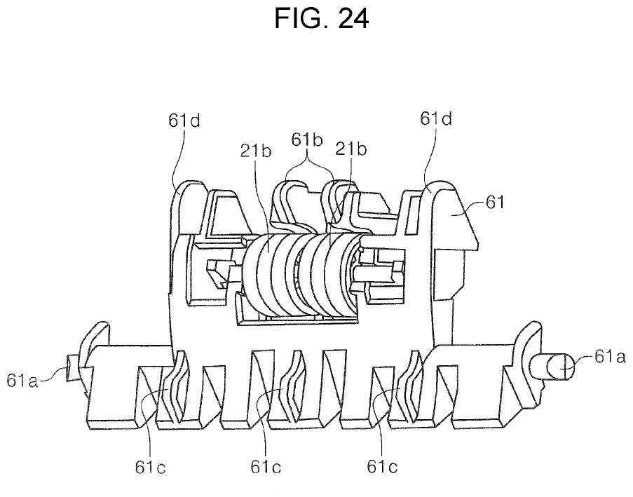

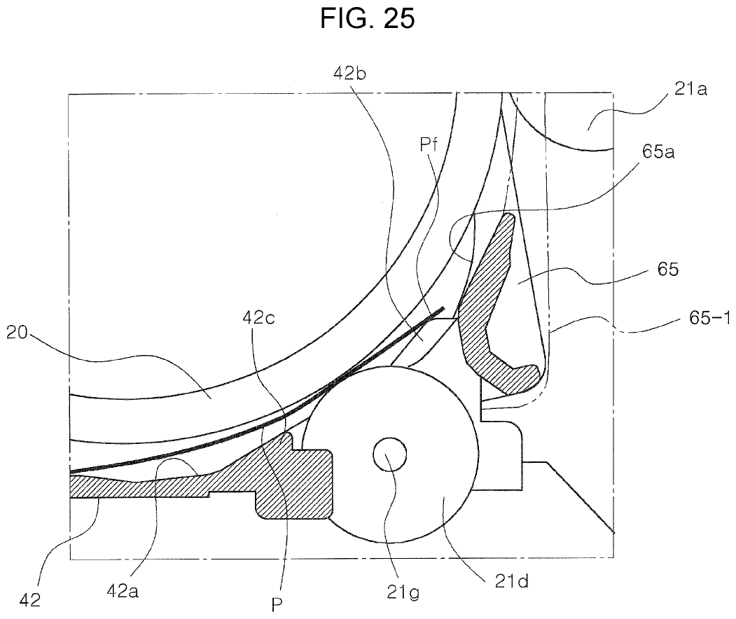

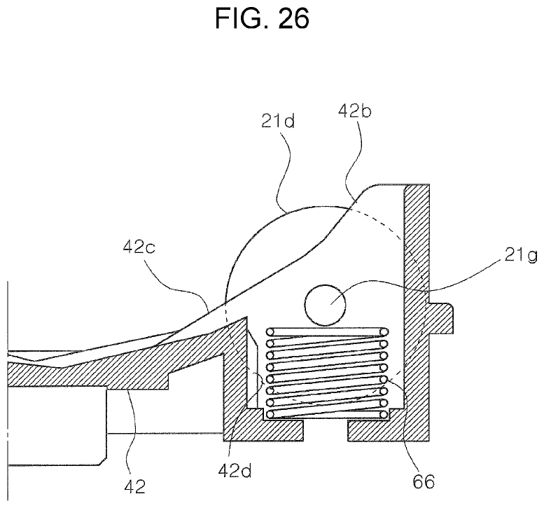

FIG. 18 is a partially enlarged view of the paper transport path of the printer 1, FIG. 19 is a view of a regulating member which regulates a progression direction of a paper leading end as viewed from a bottom side of an apparatus toward a top side, FIG. 20 is a partially enlarged view of the paper transport path of the printer 1, FIG. 21 is a perspective view illustrating another embodiment of a path member and a roller support member, FIGS. 22 and 23 are perspective views illustrating another embodiment of a roller support member, FIG. 24 is a perspective view illustrating another embodiment of a path member, FIG. 25 is a partially enlarged view of the paper transport path of the printer 1, and FIG. 26 is a lateral sectional view of a guide member.

In the x-y-z coordinate system illustrated in the FIGS. 1, 2, and 4, an x direction indicates an apparatus width direction, a paper width direction, and the movement direction of a carriage 33, a y direction indicates an apparatus depth direction and a paper transport direction, and a z direction indicates a vertical direction and an apparatus height direction. In the drawings, the +y direction side is the apparatus front surface side, and the −y direction side is the apparatus rear surface side. The +x direction side is the apparatus right side and the home position side of the carriage 33, and the −x direction side is the apparatus left side.

First, an outline description will be given of the overall configuration of the printer 1 with reference to FIGS. 1 and 2. The printer 1 is provided with a scanner unit 3 on a top portion of an apparatus main body 2 (a recording unit) which performs ink jet recording on a recording paper which serves as an example of a medium, that is, the printer 1 is configured as a multifunction device which is provided with a scanner function in addition to an ink jet recording function.

The scanner unit 3 is provided to be capable of rotating with respect to the apparatus main body 2 and is capable of assuming a closed state (FIG. 1) and an open state (not illustrated) by rotating.

The scanner unit 3 is provided with a document cover 5 which opens and closes a document stand 6 (FIG. 2).

The apparatus front surface of the apparatus main body 2 is provided with an operation panel 11 which is formed by providing a power button, operation buttons which perform various print settings and recording execution, a display unit which performs preview display or the like of print setting content and a print image, and the like.

A paper feeding cassette 13 (FIG. 2) which houses a medium is provided on a base portion of the apparatus main body 2. A front surface cover 10 is provided to be capable of opening and closing on the apparatus front surface side in the paper feeding cassette 13. FIG. 1 illustrates a state in which the front surface cover 10 is closed, and FIG. 2 illustrates a state in which the front surface cover 10 is open. A paper output port and a paper output receiving tray (described later) are exposed by opening the front surface cover 10.

The paper output receiving tray 12 is provided to be capable of assuming a state of being stored in the apparatus main body 2 by a motor (not illustrated) and a state of protruding to the front side of the apparatus main body 2 (a double dot dashed line in FIG. 1, FIG. 2), and is capable of receiving the recording paper which is subjected to recording and is output by assuming the state of protruding to the front side of the apparatus main body 2.

Next, a paper feeding port cover 4 is provided to be capable of opening and closing on the top rear portion of the apparatus main body 2, and by opening the paper feeding port cover 4, a paper setting unit 23 is exposed and it becomes possible to feed in the recording paper from diagonally above the apparatus. The paper feeding port cover 4 assumes a posture which is capable of supporting the recording paper in an inclined posture as illustrated in FIG. 2 by opening.

Next, a description will be given of a paper transport (feed) path of the printer 1 with reference mainly to FIG. 2. The printer 1 includes two paper feed paths, a paper feed path T1 from the paper feeding cassette 13 of the apparatus base portion, and a paper feed path T2 which feeds the recording paper from the paper setting unit 23 of the rear of the apparatus. The printer 1 is configured such that whichever of the paper feed paths T1 or T2 the recording paper passes, the recording paper will reliably reach the transport roller pair 30. Each of the paper feed paths is formed by path forming members, rollers, and the like.

The printer 1 is capable of executing duplex recording of the recording paper, and an arrow D which is attached to the bottom right of the intermediate roller 20 in FIG. 2 illustrates the transport direction when the recording paper which is subjected to recording on a first surface (an obverse surface) is back fed and transported toward the intermediate roller 20 again.

Next, a description will be given of the paper feed path T1 from the paper feeding cassette 13 of the apparatus base portion. A feed roller 14 is provided on the top portion of the paper feeding cassette 13. The feed roller 14 is provided on a roller support member 15 which oscillates centered on a rotating shaft 15a, and by rotating while in contact with the topmost sheet of the recording paper which is housed in the paper feeding cassette 13 and rotating, feeds out the topmost sheet of the recording paper from the paper feeding cassette 13. The feed roller 14 uses a second drive motor 153 (FIG. 3) as a drive source. A reference numeral P in FIG. 2 illustrates the recording paper which is housed in the paper feeding cassette 13.

The rotating shaft 15a configures the oscillating shaft of the roller support member 15 and transmits a drive force to the feed roller 14. The roller support member 15 lifts and lowers the feed roller 14 by oscillating centered on the rotating shaft 15a and is capable of assuming a posture which causes the feed roller 14 to contact the recording paper and a posture which causes the feed roller 14 to separate from the recording paper.

A separation inclined surface 16 is provided at a position which faces the leading end of the recording paper which is housed in the paper feeding cassette 13, and in a state in which the paper feeding cassette 13 is mounted, the leading end of the recording paper which is housed in the paper feeding cassette 13 assumes a state of being capable of abutting the separation inclined surface 16.

The separation between the topmost sheet of the recording paper to be fed and the next sheet of the paper P onward is performed by the leading end of the recording paper which is fed out proceeding to the downstream side while in contact with the separation inclined surface 16.

The intermediate roller 20 which serves as the “feed roller” and the “first roller” is provided further to the downstream side of the transport path than the separation inclined surface 16 and the recording paper is curved and inverted by the intermediate roller 20 before heading to the front side of the apparatus. The intermediate roller 20 uses the second drive motor 153 (FIG. 3) as a drive source.

A plurality of rollers which serve as “second rollers” which are capable of being driven to rotate is disposed along the circumferential direction in the intermediate roller 20. Specifically, rollers which are illustrated by reference numerals 21a, 21b, 21c, and 21d contact the intermediate roller 20 and are respectively first, second, third, and fourth driven rollers which are capable of being driven to rotate. The recording paper which is fed out from the paper feeding cassette 13 travels via the first driven roller 21a, the second driven roller 21b, and the third driven roller 21c and is fed to the transport roller pair 30.

The rollers which are described, particularly the outer circumferential surfaces of the rollers which are driven by a motor, are formed of a high-friction material. For example, it is possible to form the rollers of a non-diene rubber of which EPDM is representative, a diene rubber, a thermoplastic elastomer, or the like. Among the driven rollers which are driven and rotated in contact with the rollers which are driven by the motor, each of the driven rollers which are illustrated by reference numerals 21a, 21b, 21c and 21d will be described in detail later.

Next, the transport roller pair 30 which transports the recording paper to under a recording head 35 is a roller pair which is configured by a transport drive roller 30a and a transport driven roller 30b. The transport drive roller 30a uses a first drive motor 151 (FIG. 3, described later) as a motive force source and is rotationally driven. The transport driven roller 30b is driven to rotate while in contact with the transport drive roller 30a or the paper which is transported.

The transport drive roller 30a is formed to be provided with a high-friction layer on the surface of a metal shaft body, the transport driven roller 30b is formed by a low-friction material (for example, POM) and a plurality are provided at a suitable interval along the axial line direction of the transport drive roller 30a. The transport driven roller 30b is provided in a state of being biased toward the transport drive roller 30a by a biasing unit (not illustrated).

The recording head 35 which serves as a recorder and a platen 31 are disposed to face each other on the downstream of the transport roller pair 30. The recording head 35 discharged an ink under the control of a control unit 150 (FIG. 3).

The carriage 33 which is provided with the recording head 35 is provided to be capable of moving reciprocally in a scanning direction (the x direction) of the recording head 35 and obtains motive force from a motive force source (not illustrated) to operate in the scanning direction of the recording head 35. The motive force source is controlled by the control unit 150 (FIG. 3, described later)

The platen 31 defines a gap between the recording head 35 and the recording paper by supporting the recording paper.

An output roller pair 37 which is configured by an output drive roller 37a and an output driven roller 37b is provided downstream of the recording head 35 and the platen 31. The output drive roller 37a uses the first drive motor 151 (FIG. 3, described later) as a motive force source and is rotationally driven. The output driven roller 37b is driven to rotate while in contact with the output drive roller 37a or the paper which is transported.

The output drive roller 37a is formed of a high-friction material. For example, it is possible to form the output drive roller 37a a non-diene rubber of which EPDM is representative, or else, a diene rubber, a thermoplastic elastomer, or the like. The output driven roller 37b is a so-called star wheel which makes point contact with the recording paper.

The recording paper on which the recording is performed is output toward the paper output receiving tray 12 of the front side of the apparatus by the output roller pair 37.

In a case in which both surfaces of the recording paper are recorded, by performing a switch-back after recording the first surface (the obverse surface) with the recording head 35, the recording paper is fed between the intermediate roller 20 and the fourth driven roller 21d, and by inverting the recording paper with the intermediate roller 20, it becomes possible to perform recording on the second surface (a reverse surface) of the recording paper.

In the printer 1, in addition to the feeding of the paper from the paper feeding cassette 13 of the apparatus base portion, the printer 1 is configured to be capable of performing feeding in of the recording paper from diagonally above. Reference numeral 23 in FIG. 2 is a paper setting unit which sets the recording paper which is inserted from diagonally above, reference numeral 24 is a feed roller which feeds the recording paper which is fed in from diagonally above, and reference numeral 25 is a driven roller.

Reference numeral T2 illustrates the feed path of the recording paper which is fed out from the paper setting unit 23.

Next, a description will be given of the control system of the printer 1 with reference to FIG. 3. The control unit 150 which serves as a controller which performs various control of the printer 1 acquires recording data which is data for performing the recording and is generated by a printer driver which operates on an external computer (not illustrated) or a printer driver with which the control unit 150 is provided. A motor driver 152 which is a driver of the recording head 35 and the first drive motor 151, a motor driver 154 which is a driver of the second drive motor 153, and the like are controlled based on the recording data and input information from the operation panel 11.

The control unit 150 performs the necessary control based on the detection states of various sensors. In FIG. 3, rotary encoders 155 and 156 and a paper detection sensor 29 are illustrated as examples of the various sensors. The rotary encoder 155 detects the rotation of the second drive motor 153 and the control unit 150 ascertains the rotation direction, the rotation speed, and the rotation amount of the second drive motor 153, and so the rollers, based on the detection signal from the rotary encoder 155. The same applies to the rotary encoder 156. The paper detection sensor 29 is provided in the vicinity of the upstream of the transport roller pair 30 as illustrated in FIG. 2 and detects the passing of the leading end or the rear end of the recording paper.

In the present embodiment, the transport drive roller 30a and the output drive roller 37a use the first drive motor 151 as the drive source. The feed roller 14, the intermediate roller 20, and the feed roller 24 use the second drive motor 153 as the drive source.

Hereunto is the overall configuration of the printer 1, and hereinafter a description will be given of a skew rectification operation which is controlled by the control unit 150 with reference to FIG. 4 onward.

First, a description will be given of a bending space of the recording paper which is necessary for the skew rectification with reference to FIG. 4.

In FIG. 4, reference numerals 40, 41, and 42 are guide members which guide the recording paper from between the intermediate roller 20 and the third driven roller 21c toward the transport roller pair 30 of the downstream side. The recording paper which is fed from between the intermediate roller 20 and the third driven roller 21c toward the transport roller pair 30 is capable of bending during the skew rectification within a space Ar which is formed by the guide members 40, 41, and 42. Reference numeral Pr illustrates a bending portion which is formed in the recording paper. It is possible to form sufficient bending in the recording paper during the skew rectification to the extent that the space Ar is large. In other words, when a reduction in the size of the apparatus is obtained, the space Ar becomes smaller, and the bending amount of the recording paper is restricted.

In particular, in the present embodiment, the guide member 40 is disposed between the intermediate roller 20 and the transport roller pair 30 in order to feed the recording paper from diagonally above in the paper setting unit 23. Therefore, the space Ar is yet further restricted.

The space which is illustrated by reference numeral Af is set to the paper setting unit 23 and the recording paper which is fed by the feed roller 24 is a space in which the recording paper is capable of bending during the skew rectification. Reference numeral 43 is a support member which supports the transport driven roller 30b.

Next, a detailed description will be given of the configuration surrounding the second driven roller 21b which serves as the “second roller” with reference to FIGS. 10 to 17.

As illustrated in FIGS. 10 and 11, the second driven roller 21b is supported by the roller support member 51, and the roller support member 51 is supported by the path member 50.

The path member 50 is provided to extend in the paper width direction and a plurality of ribs 50a which extend along the paper transport direction are provided on the surface which forms the paper transport path at an appropriate interval along the paper width direction.

Shaft holding units 50b and 50b are provided in the path member 50, and the roller support member 51 is provided to be capable of oscillating with respect to the path member 50 due to the oscillating shafts 51a and 51a being supported by the shaft holding units 50b and 50b. The second driven roller 21b proceeds and retracts with respect to the paper transport path due to the oscillation of the roller support member 51. The oscillating shaft 51a of the roller support member 51 is positioned on the upstream side of the second driven roller 21b in the paper transport direction.

A spring 53 which serves as a biasing unit is provided between the path member 50 and the roller support member 51, and the roller support member 51 is provided in a state in which the second driven roller 21b is biased in the direction of progression the paper transport path by the biasing force of the spring 53.

The second driven roller 21b is supported by the roller support member 51 via a rotating shaft 52 as illustrated in FIG. 12. In the present embodiment, two of the second driven rollers 21b are provided with respect to the roller support member 51. More specifically, in the present embodiment, the intermediate roller 20 which serves as a feed roller and the driven rollers which contact the intermediate roller 20 are provided in an intermediate position in the paper width direction, and two of the second driven rollers 21b are disposed with respect to the one intermediate roller 20, that is, a plurality of the second driven rollers 21b is provided with respect to the width of the intermediate roller 20.

As illustrated in FIG. 13, bearing surfaces (tubular surfaces) 51d and 51d are formed on the roller support member 51 and the rotating shaft 52 is axially supported by the bearing surfaces 51d and 51d. Shaft regulating portions 51b and 51b are provided on the roller support member 51, and the position of the rotating shaft 52 in the axial line direction is regulated by the shaft regulating portions 51b and 51b. Reference numeral 51c illustrates the shaft regulating surface which is the surface which the shaft end of the rotating shaft 52 abuts in the shaft regulating unit 51b.

As illustrated in FIGS. 14 to 16, the second driven roller 21b is provided with an outer circumferential surface 22a, an outside end surface 22e, an inside end surface 22d, a shaft hole 22g, and a tubular portion 22h, and the entirety of the second driven roller 21b is formed integrally by a resin material.

In the present embodiment, including the second driven roller 21b, the driven rollers which contact the intermediate roller 20 use grade L5000 among Mitsui Chemicals Inc. high sliding property polyethylene “LUBMER” (trademark of Mitsui Chemicals Inc.), for example.

The driven rollers are not limited to this material; however, it is preferable to use a material with as low a friction coefficient as possible between the outer circumferential surfaces 22a of the rollers and the paper.

Corner portions 22b and 22c of the outer circumferential surface 22a of the second driven roller 21b are chamfered and are formed in R-shapes. Accordingly, the second driven roller 21b is configured such that roller marks are not easily formed on the paper when the second driven roller 21b contacts the paper.

The second driven roller 21b is formed such that the inside end surface 22d side and the outside end surface 22e side are different shapes (are non-symmetrical). Specifically, the inside end surface 22d side and the tubular portion 22h are formed to protrude to approximately the same position as the inside end surface 22d which is a roller end surface.

The two second driven rollers 21b are disposed such that the inside end surfaces 22d face each other as illustrated in FIG. 16. Here, a protrusion 51f which protrudes toward the second driven roller 21b as illustrated in FIG. 13 is provided at a position facing the second driven roller 21b in the roller support member 51. Hypothetically, even if the second driven roller 21b is attached with the orientation of the second driven roller 21b in an erroneous state, that is, even if the second driven roller 21b is erroneously attached in a state in which the outside end surface 22e is on the inside, the configuration is such that the protrusion 51f abuts the tubular portion 22h and may not be attached. In other words, the protrusion 51f and the tubular portion 22h configure a unit which prevents erroneous assembly.

In FIG. 13, the protrusion 51f which is provided with respect to one side of the two second driven rollers 21b is represented; however, the same protrusion 51f is also provided for the other side.

Next, as illustrated in FIG. 16, a convex portion 21f is formed on the inner circumferential portion (the shaft hole 22g) of the second driven roller 21b. The convex portion 21f reduces the contact range with the rotating shaft 52 and the second driven roller 21b is capable of oscillating (inclining) as illustrated in FIG. 17 with respect to the rotating shaft 52 using the convex portion 21f as a fulcrum.

Reference numeral a in FIG. 16 illustrates the formation range of the convex portion 21f, reference numeral L1 in FIG. 17 illustrates an axial middle line of the rotating shaft 52, and reference numeral L2 illustrates the rotating shaft center line when the second driven roller 21b rotates. Reference numeral a illustrates the angle which is formed between the axial middle line L1 of the rotating shaft 52 and the rotating shaft center line L2 of the second driven roller 21b when the second driven roller 21b oscillates with respect to the rotating shaft 52.

Reference numeral D illustrates the paper transport direction, and in the example of FIG. 17, the axial middle line L1 of the rotating shaft 52 does not correctly form a right angle with respect to the paper transport direction D and is in a state of having an assembly error.

However, the convex portion 21f which is described above is formed on the inner circumferential portion of the second driven roller 21b, and the second driven roller 21b oscillates with respect to the rotating shaft 52 using the convex portion 21f as a fulcrum in accordance with the transporting of the paper, that is, the angle which is formed between the paper transport direction D and the rotating shaft center line L2 of the second driven roller 21b is adjusted. Therefore, even in a case in which, hypothetically, the attachment precision of the second driven roller 21b is poor and the rotating shaft center line L2 is not perpendicular with respect to the paper transport direction D, by causing the second driven roller 21b (the rotating shaft center line L2) to follow a direction which is perpendicular to the paper transport direction D in accordance with the transporting of the paper, the paper transport direction which results from the intermediate roller 20 and the second driven roller 21b is adjusted to a more appropriate direction and so it is possible to suppress skewing.

As described above, the convex portion 21f configures an adjustment unit which adjusts the angle which is formed between the paper transport direction D and the rotating shaft center line L2 of the second driven roller 21b.

In the present embodiment, the second driven roller 21b is provided to be capable of being displaced along the axial line direction (a direction along the axial middle line L1) of the rotating shaft 52, and as illustrated in FIG. 16, regulating portions 51e which are on both sides of the second driven roller 21b in the axial line direction and which regulate the displacement of the second driven roller 21b in the axial line direction are provided on the roller support member 51 closer to the upstream side than the rotating shaft 52 in the paper transport direction. The disposing interval of the regulating portions 51e is greater than the roller width of the second driven roller 21b and thus the second driven roller 21b is capable of being displaced along the axial line direction (a direction along the axial middle line L1) of the rotating shaft 52.

The regulating portions 51e are provided in three locations in the present embodiment. In FIG. 17, the main body of the roller support member 51 is omitted from the drawings and only the regulating portions 51e are illustrated for the convenience of illustration.

According to this configuration, even in a case in which the attachment precision of the second driven roller 21b is poor and the rotating shaft center line L2 is not perpendicular with respect to the paper transport direction D, in the example illustrated in FIG. 17, for example, the second driven roller 21b moves in the left direction in FIG. 17 and abuts the regulating portion 51e of the left side. The second driven roller 21b is capable of oscillating using the abutting part as a fulcrum. In other words, the second driven roller 21b is capable of easily oscillating centered on the abutting part between the second driven roller 21b and the regulating portion 51e and it is possible to easily adjust the angle which the rotating shaft center line L2 of the second driven roller 21b forms with the paper transport direction D.

In the present embodiment, the roller which is provided with a unit for adjusting the angle of the rotating shaft center line with respect to the paper transport direction is provided with respect to the second driven roller 21b among the driven rollers, a plurality of which are provided with respect to the intermediate roller 20; however, instead of or additionally, the roller may be provided with respect to the third driven roller 21c, for example. In other words, by providing the angle adjustment unit with respect to at least the driven roller (the third driven roller 21c) which is positioned first on the upstream side of the transport roller pair 30 or the driven roller (the second driven roller 21b) which is positioned first on the upstream side of the aforementioned driven roller, that is, the driven roller which has a great influence on the skew rectification, it is possible to effectively rectify the skewing.

However, the angle adjustment unit may be provided with respect to another driven roller which does not greatly influence the skew rectification.

In the present embodiment, a plurality of the second driven rollers 21b is provided with respect to the intermediate roller 20; however, it is possible to obtain the operational effect of the angle adjustment unit even with a configuration in which only one of the second driven rollers 21b is provided with respect to the intermediate roller 20.

The more driven rollers that nip the recording paper between the driven rollers and the intermediate roller 20, the more it is possible to suppress the skewing of the recording paper by the point at which the recording paper reaches the transport roller pair 30. In the present embodiment, the skewing of the recording paper by the point at which the recording paper reaches the transport roller pair 30 is suppressed by the three driven rollers, the first driven roller 21a, the second driven roller 21b, and the third driven roller 21c.

It is preferable to provide more of the intermediate rollers 20 and the driven rollers which contact the intermediate rollers 20 in the paper width direction from the perspective of skew suppression. In the present embodiment, the intermediate roller 20 and the driven rollers which contact the intermediate roller 20 are provided at an intermediate position in the paper width direction; however, for example, it is more preferable to provide a plurality along the paper width direction at a suitable interval from the perspective of skew suppression.

Next, a description will be given of another embodiment of the configuration surrounding the intermediate roller 20 with reference to FIGS. 18 to 26.

In FIGS. 18 and 19, reference numeral 26 illustrates a regulating member which regulates the progression direction of the leading end of the paper P. In other words, when the paper P is inverted by the intermediate roller 20 for the duplex printing, there is a concern that the leading end of the paper P will curl downward as illustrated by dashed line Pj resulting in the paper P not appropriately proceeding to the downstream side and jamming. However, since the progression direction of the paper leading end is regulated to face the downstream side more by the regulating member 26, it is possible to suppress jamming which accompanies the cause which is described above.

When the paper P is inverted by the intermediate roller 20, there is a case in which the paper leading end which proceeds to the downstream side from the intermediate roller 20 comes into contact with the paper rear end region before the inversion, and when the friction coefficient between the obverse surface and the reverse surface of the paper is high at this time, there is a concern that the paper leading end may not slide on the paper obverse surface, leading to jamming.

However, as described above, since the progression direction of the paper leading end is regulated to face the downstream side more by the regulating member 26, it is possible to suppress jamming which accompanies the cause which is described above.

The regulating member 26 is provided on both sides of the intermediate roller 20 which is in the center region in the paper width direction which is a direction which is perpendicular to the paper transport direction. The regulating member 26 is formed by a sheet material which has elasticity in the present embodiment. By forming the regulating member 26 using the sheet material which has elasticity, it is possible to suppress formation of damage or the like to the paper P.

Reference numeral 27 in FIG. 19 is a regulating member which regulates the progression direction of the paper end portion region. In the present embodiment, the regulating member 27 is provided to extend further to the downstream side in the paper transport direction than the regulating member 26. The regulating member 27 is also formed by a sheet material which has elasticity in the same manner as the regulating member 26 in the present embodiment.

Next, as illustrated in FIG. 21, the second driven roller 21b is supported by a roller support member 61, and the roller support member 61 is supported by a path member 60. The first driven roller 21a is supported by the roller support member 62. The path member 60 is another embodiment of the path member 50 which is already described with reference to FIG. 10, and similarly, the roller support member 61 is another embodiment of the roller support member 51.

The path member 60 is provided to extend in the paper width direction and a plurality of ribs 60a which extend along the paper transport direction are provided on the surface which forms the paper transport path at an appropriate interval along the paper width direction.

Shaft holding units 60b and 60b are provided in the path member 60, and the roller support member 61 is provided to be capable of oscillating with respect to the path member 60 due to oscillating shafts 61a and 61a (FIG. 24) being supported by the shaft holding units 60b and 60b. The second driven roller 21b proceeds and retracts with respect to the paper transport path due to the oscillation of the roller support member 61. The oscillating shaft 61a of the roller support member 61 is positioned on the upstream side of the second driven roller 21b in the paper transport direction. In the roller support member 61, the second driven roller 21b is biased in a direction in which contact is made with the intermediate roller 20 by a biasing unit (not illustrated).

The roller support member 62 includes oscillating shafts 62a and 62a (FIGS. 21 and 22) and due to the oscillating shafts 62a and 62a being supported by a frame (not illustrated) in FIG. 21, the roller support member 62 is capable of oscillating. The first driven roller 21a proceeds and retracts with respect to the paper transport path due to the oscillation of the roller support member 62. The oscillating shaft 62a of the roller support member 62 is positioned on the upstream side of the first driven roller 21a in the paper transport direction. In the roller support member 62, the first driven roller 21a is biased in a direction in which contact is made with the intermediate roller 20 by a biasing unit (not illustrated).

As illustrated in FIG. 20, regulating portions 67, 68, and 69 which configure “a jump regulating portion” are provided on the downstream side of the nipping position between the intermediate roller 20 and the first driven roller 21a. The regulating portions 67, 68, and 69 regulate the jumping of the paper rear end Pr which deviates from the nipping position between the intermediate roller 20 and the first driven roller 21a to the first driven roller 21a side.

In other words, when the paper rear end Pr deviates from the nipping position between the intermediate roller 20 and the first driven roller 21a, since the paper which curves along the outer circumferential surface of the intermediate roller 20 is apt to return to the original state, a phenomenon in which the paper rear end Pr is apt to jump (spring) up from the intermediate roller 20 arises, and there is a concern that at this time the paper transport precision will be disturbed and, as a result, the recording quality will be disturbed.

However, since the regulating portions 67 and 68 and the regulating portion 69 which is provided on the downstream side of the regulating portions 67 and 68 regulate the jumping of the paper rear end Pr which deviates from the nipping position between the intermediate roller 20 and the first driven roller 21a to the first driven roller 21a side, it is possible to suppress the disturbance to the recording quality.

The regulating portion 67 is provided on the roller support member 62, the regulating portion 68 is provided on the path member 60, and the regulating portion 69 is provided on the roller support member 61.

FIG. 22 is a perspective view illustrating the roller support member 62. Ribs 62b, 62c, and 62d are formed on the roller support member 62 at a suitable interval along the paper width direction and the ribs configure the regulating portion 67 of FIGS. 20 and 21.

As illustrated in FIG. 23, a plurality (in the present embodiment, two) of the ribs 60c and 60c are formed on the path member 60 leaving a predetermined interval in the paper width direction. The ribs 60c and 60c the regulating portion 68 of FIGS. 20 and 21.

In the present embodiment, the regulating portion 67 is provided selectively in the center region in the paper width direction; however, the regulating portions 67 and 68 may be provided across the entirety of the paper width direction.

In the present embodiment, the regulating portion 68 is provided on the end portion side in the paper width direction of the regulating portion 67 in the paper width direction; however, the regulating portion 68 may be provided across the entirety of the paper width direction.

FIG. 24 is a perspective view illustrating the roller support member 61. A plurality of ribs 61c, 61c, and 61c are formed on the roller support member 61 at a predetermined interval in the paper width direction. The ribs 61c, 61c, and 61c configure the regulating portion 69 of FIGS. 20 and 21.

In the present embodiment, the regulating portion 69 is provided selectively in the center region in the paper width direction; however, the regulating portion 69 may be provided across the entirety of the paper width direction.

As illustrated in FIG. 20, a regulating portion 70 which serves as a similar “a jump regulating portion” is provided on the downstream side of the nipping position between the intermediate roller 20 and the second driven roller 21b. The regulating portion 70 regulates the jumping of the paper rear end Pr which deviates from the nipping position between the intermediate roller 20 and the second driven roller 21b to the second driven roller 21b side.

As illustrated in FIG. 23, the regulating portion 70 is configured by ribs 61b, 61b, 61d, and 61d which are provided on the roller support member 61.

In the present embodiment, the regulating portion 70 is provided selectively in the center region in the paper width direction; however, the regulating portion 70 may be provided across the entirety of the paper width direction.

Next, as illustrated in FIG. 25, a guide 42b which moderates the abutting angle of a flap 65 is formed on the guide member 42 which guides the paper P which is subjected to recording on the first surface (the obverse surface) and is switched back to the intermediate roller 20.

In other words, the flap 65 which switches between a feed path of the paper which goes from the paper feeding cassette 13 toward the intermediate roller 20 and a transport path of the paper P which is subjected to recording on the first surface (the obverse surface) and is switched back is provided in the vicinity of the fourth driven roller 21d. The flap 65 is provided to be capable of oscillating centered on an oscillating shaft (not illustrated) and is configured to be capable of switching between a posture (the solid line of FIG. 25) in which the feed path of the paper which goes from the paper feeding cassette 13 toward the intermediate roller 20 is opened, and a posture (the double dot and dash line and reference numeral 65-1 of FIG. 25) in which the transport path of the paper P which is subjected to recording on the first surface (the obverse surface) and is switched back is opened.

As illustrated by the solid line of FIG. 25, when the flap 65 assumes the posture in which the feed path of the paper which goes from the paper feeding cassette 13 toward the intermediate roller 20 is opened, a leading end Pf of the paper P which is subjected to recording on the first surface (the obverse surface) and is switched back abuts the flap 65 at a sharp angle and may jam. Since the guide 42b suppresses such problems, the guide 42b guides the paper leading end Pf such that the angle when the leading end Pf of the paper P abuts the flap 65 is moderated.

A guide 42c is formed on the guide member 42. The guide 42c functions as described below. In other words, as illustrated in FIG. 26, a spring 66 which functions as a pressing member which presses a rotating shaft 21g to the intermediate roller 20 side is provided downstream of the rotating shaft 21g of the fourth driven roller 21d; however, when the installation position of the spring 66 is close to the upstream side (the left side in FIG. 26), there is a concern that the top end corner portion of the spring 66 will jut into the paper transport path and the paper will catch on the jutting portion. The guide 42c suppresses the problems by guiding the paper in a direction distancing from the spring 66.

A regulating rib 42d is provided on the upstream side (the left side in FIG. 26) with respect to the housing region of the spring 66 and the installation position of the spring 66 is suppressed from approaching the upstream side by the regulating rib 42d.

Next, a description will be given of the specific skew rectification operation in the printer 1 with reference to FIGS. 5 to 8. The control unit 150 is configured to be capable of executing a first skew rectification operation, a second skew rectification operation, and further, a combined skew rectification mode in which the first skew rectification operation and the second skew rectification operation are combined.

The first skew rectification operation is an operation of abutting the paper leading end against the transport roller pair 30 in accordance with the formation of bending of the recording paper between the intermediate roller 20 and the third driven roller 21c and the transport roller pair 30 using the backward rotation of the transport roller pair 30 and the forward rotation of the intermediate roller 20. Hereinafter, for the convenience of description, the first skew rectification operation will be referred to as the skew rectification operation of “the backward rotating abutting system”.

The second skew rectification operation is an operation of feeding the leading end of the recording paper from the nipping position of the transport roller pair 30 to the downstream side by a predetermined amount, subsequently causing the transport roller pair 30 to rotate backward without driving the intermediate roller 20, discharging the leading end of the recording paper to the upstream side of the transport roller pair 30, and causing the paper leading end to conform to the nipping position of the transport roller pair 30. Hereinafter, for the convenience of description, the second skew rectification operation will be referred to as the skew rectification operation of “the take-in discharge system”.

However, in the skew rectification operation of the backward rotating abutting system, when the diameter of the transport roller pair 30 is reduced in size in order to reduce the size of the apparatus, as illustrated in FIG. 5, there is a case in which the paper leading end Pf is not guided to the nipping position of the transport roller pair 30, collides (abuts) with the roller circumferential surface of the transport drive roller 30a, and the skew rectification may not be performed appropriately.

FIG. 5 and FIGS. 6 and 7 which are used in the description later schematically illustrate the size and the disposing interval of each of the rollers for the convenience of description, and also schematically illustrate the shape and size of the bending of the recording paper. FIGS. 5 to 7 aim to wholly illustrate the relationship between the position of the paper leading end and the rotation directions of the rollers.

The control unit 150 executes the combined skew rectification mode as necessary.

Hereinafter, first, an outline description will be given of the flow of the recording operation according to the present example with reference to FIG. 8.

In FIG. 8, the control unit 150 acquires feed path information based on driver information (step S101) and acquires paper type and paper size information from the driver information (step S102). The control unit 150 sets the skew rectification method based on the feed path information which is acquired in step S101 and the paper type and paper size information which is acquired in step S102 (step S103).

The skew rectification method of step S103 is stored in a memory as a preset table, the content of which will be described later.

Next, the control unit 150 performs the feeding of the paper and the skew rectification based on the skew rectification method which is set in step S103 (step S104) and executes the recording on the first surface (the obverse surface) (step S105).

Next, in the case of simplex recording (No in step S106), the control unit 150 outputs the recording paper (step S110).

In the case of duplex recording (Yes in step S106), the control unit 150 sets the same skew rectification method as in step S103 again (step S107), performs the inversion of the paper and the skew rectification based on the skew rectification method which is set (step S108), and executes the recording on the second surface (the reverse surface) (step S109). Next, the control unit 150 outputs the recording paper (step S110).

Here, the setting of the skew rectification method of steps S103 and S107 are performed according to the feed path, the paper type, and the paper size as described above.

In the present example, for example, the setting is performed as illustrated in FIG. 9.

Specifically, in the case of the paper feed path T1 (paper feeding from the paper feeding cassette 13) or the case of duplex recording, if the recording paper is a postcard, the combined skew rectification mode is selected. In a case in which the recording paper is ordinary paper, only the skew rectification operation of the take-in discharge system (the second skew rectification operation) is executed, and if the recording paper is anything else, only the skew rectification operation of the backward rotating abutting system (the first skew rectification operation) is executed.

In the case of the paper feed path T2 (paper feeding from the paper setting unit 23), if the recording paper is a postcard or ordinary paper, only the skew rectification operation of the take-in discharge system (the second skew rectification operation) is executed, and if the recording paper is anything else, only the skew rectification operation of the backward rotating abutting system (the first skew rectification operation) is executed.

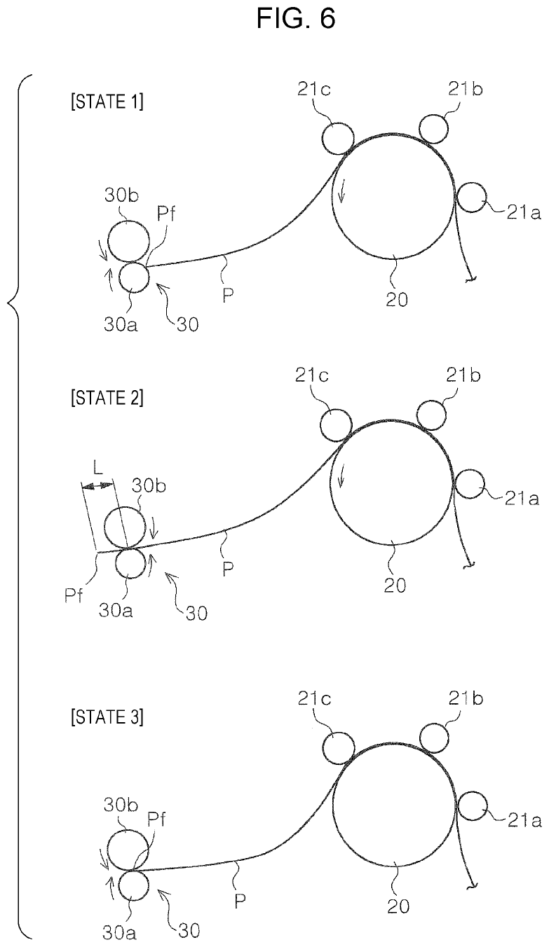

Hereinafter, a description will be given of the specific examples and operational effects of the combined skew rectification mode with reference to FIG. 6.

FIG. 6 describes the combined skew rectification mode in which the skew rectification operation of the backward rotating abutting system (the first skew rectification operation) is executed first and the skew rectification operation of the take-in discharge system (the second skew rectification operation) is executed next.

A “state 1” of FIG. 6 illustrates a state in which the skew rectification operation of the backward rotating abutting system is executed. The recording paper P which is fed out from the intermediate roller 20 and the third driven roller 21c reaches the transport roller pair 30 which rotates backward. In the recording paper P, bending is formed between the transport roller pair 30 and the intermediate roller 20 and the paper leading end Pf abuts the transport roller pair 30. At this time, as illustrated with reference to FIG. 5, there is a case in which the paper leading end Pf abuts the transport drive roller 30a.

Next, the skew rectification operation of the take-in discharge system (the second skew rectification operation) is executed. A “state 2” of FIG. 6 illustrates a state (a take-in state) in which the paper leading end Pf is fed out to the downstream side by a predetermined amount L from the nipping position of the transport roller pair 30 in the skew rectification operation of the take-in discharge system.

From this state, in a state in which the intermediate roller 20 is stopped, when the transport roller pair 30 is caused to rotate backward, the paper leading end Pf is discharged to the upstream side of the transport roller pair 30. Bending is formed in the recording paper P between the transport roller pair 30 and the intermediate roller 20 as illustrated in “state 3” of FIG. 6, and the paper leading end Pf conforms to the nipping position of the transport roller pair 30 and the skewing is rectified.

As described above, according to the combined skew rectification mode in which the skew rectification operation of the take-in discharge system is performed after performing the skew rectification operation of the backward rotating abutting system, by first performing the skew rectification operation of the backward rotating abutting system (“state 1” of FIG. 6), even if abutment of the paper leading end Pf to the transport roller pair 30 occurs, a certain degree of skew rectification may be anticipated.

By subsequently performing the skew rectification operation of the take-in discharge system (“state 2” and “state 3” of FIG. 6), in the end, the abutment of the paper leading end Pf to the transport roller pair 30 is avoided and it is possible to rectify the skewing. Additionally, since a certain degree of skew rectification is performed by the skew rectification operation of the backward rotating abutting system before the skew rectification operation of the take-in discharge system, it is possible to compensate for faults in the skew rectification operation of the take-in discharge system (the effect of the skew rectification being inferior in comparison to the skew rectification of the backward rotating abutting system), and as a result it is possible to appropriately rectify the skewing.

In particular, even if the diameter of each of the rollers (particularly the transport drive roller 30a in the present embodiment) which configure the transport roller pair 30 is reduced in size in accordance with a reduction in the size of the apparatus, it is possible to appropriately rectify the skewing.

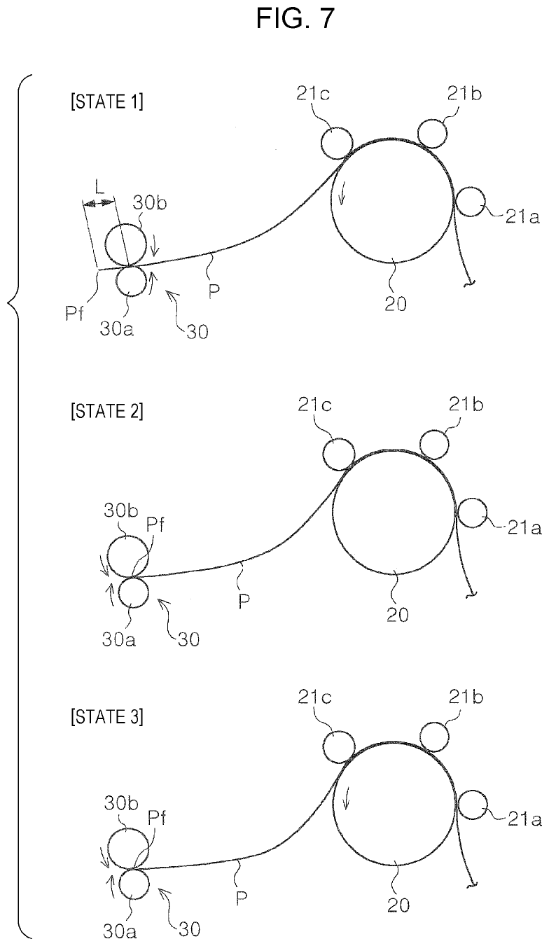

Next, FIG. 7 describes the combined skew rectification mode in which the skew rectification operation of the take-in discharge system (the second skew rectification operation) is executed first and the skew rectification operation of the backward rotating abutting system (the first skew rectification operation) is executed next, the reverse of the order in FIG. 6.

A “state 1” of FIG. 7 illustrates a state (a take-in state) in which the paper leading end Pf is fed out to the downstream side by the predetermined amount L from the nipping position of the transport roller pair 30 in the skew rectification operation of the take-in discharge system.

From this state, in a state in which the intermediate roller 20 is stopped, when the transport roller pair 30 is caused to rotate backward, the paper leading end Pf is discharged to the upstream side of the transport roller pair 30. Bending is formed in the recording paper P between the transport roller pair 30 and the intermediate roller 20, and the paper leading end Pf conforms to the nipping position of the transport roller pair 30 and the skewing is rectified (a “state 2” of FIG. 7).

Next, in a state in which the transport roller pair 30 is caused to rotate backward, the paper leading end Pf abuts the nipping position of the transport roller pair 30 via the forward rotation of the intermediate roller 20. Bending is formed in the recording paper P between the transport roller pair 30 and the intermediate roller 20, and the paper leading end Pf conforms to the nipping position of the transport roller pair 30 and the skewing is rectified (a “state 3” of FIG. 7).

As described above, according to the combined skew rectification mode in which the skew rectification operation of the backward rotating abutting system is performed after performing the skew rectification operation of the take-in discharge system, it is possible to avoid the abutment of the paper leading end Pf to the transport roller pair 30 and to cause the paper leading end Pf to appropriately reach the nipping position of the transport roller pair 30 (the “state 2” of FIG. 7).

Additionally, in a case in which the skew rectification operation of the take-in discharge system is performed only one time to perform the skew rectification, in consideration of oblique motion of the paper leading end Pf, it is necessary to increase the take-in amount (the reference numeral L in the “state 1” of FIG. 7) in order to reliably cause the paper leading end Pf to be taken into the transport roller pair 30, and thus, the bending amount between the transport roller pair 30 and the intermediate roller 20 after the paper leading end Pf is discharged upstream of the transport roller pair 30 and there is a case in which a reduction in the size of the apparatus may not be supported.

However, since the combined skew rectification operation of the take-in discharge system which is executed first in the skew rectification mode is a so-called preparatory operation before performing the next skew rectification operation of the backward rotating abutting system, the take-in amount (the reference numeral L in the “state 1” of FIG. 7) may be little. In other words, even if the apparatus is reduced in size and the space in which the recording paper P is capable of bending is narrow, it is possible to support this configuration.

By subsequently performing the skew rectification operation of the backward rotating abutting system, it is possible to appropriately rectify the skewing of the recording paper P.

In particular, even if the diameter of the rollers which configure the transport roller pair 30 is reduced in size in accordance with a reduction in the size of the apparatus, it is possible to appropriately rectify the skewing.

In this example, the paper feeding cassette 13 which serves as a first setting unit and the paper setting unit 23 which serves as a second setting unit which are capable of setting the recording paper, the intermediate roller 20 which serves as a feed roller is a roller which inverts the recording paper which is fed out from the paper feeding cassette 13 toward the transport roller pair 30, and a configuration is adopted in which the recording paper which is fed out from the paper setting unit 23 is fed to the transport roller pair 30 without being inverted. In this configuration, the control unit 150 does not select the combined skew rectification mode in a case in which the recording paper is fed from at least the paper setting unit 23 as illustrated in FIG. 9 (in a case in which the paper feed path T2 is used).

In other words, in a case in which the recording paper is fed in a feed path in which skewing does not occur easily, since the combined skew rectification mode is not selected, it is possible to suppress a reduction in the throughput.

In the present embodiment, the control unit 150 selects the combined skew rectification mode according to the size of the recording paper. More specifically, in the present embodiment, in a case in which the paper size is postcard, that is, in a case in which the paper size is small, since the combined skew rectification mode is selected, it is possible to appropriately rectify the skewing of the recording paper of a small size in which skewing occurs easily. It is possible to suppress a reduction in throughput by not applying the combined skew rectification mode to the recording paper of a large size in which skewing does not occur easily.

The example which is described above can be modified as follows, for example.

(1) In this example, in a case of a postcard or a paper type other than ordinary paper, the control unit 150 uniformly performs only the skew rectification operation of the backward rotating abutting system; however, for example, in a case in which the paper is thick, the combined skew rectification mode may be adopted. In the case of the thick paper, since the rigidity of the paper is high, abutment of the paper leading end to the transport drive roller 30a occurs easily. Accordingly, in such a case, if the combined skew rectification mode which is described with reference to FIG. 6 or FIG. 7 is applied, it is possible to suppress the abutment of the paper leading end to the transport drive roller 30a and to more appropriately rectify the skewing.

In this manner, if the combined skew rectification mode is selected according to the paper type, it is possible to suppress a reduction in throughput by not applying the combined skew rectification mode to recording paper in which abutment of the paper leading end to the transport roller pair 30 does not occur easily, and it is possible to appropriately rectify skewing by applying the combined skew rectification mode to recording paper in which abutment of the paper leading end to the transport roller pair 30 occurs easily.

(2) In a configuration which is provided with an inversion path in which, after performing the recording on the first surface (the obverse surface), the recording paper is fed into the intermediate roller 20 again, the recording paper is inverted such that the second surface (the reverse surface) of the opposite side from the first surface faces the recording head 35, the control unit 150 may select the combined skew rectification mode according to the surface of the paper on which to perform the recording.

Accordingly, it is possible to suppress a reduction in throughput by not selecting the combined skew rectification mode in a situation in which the abutment of the paper leading end to the transport roller pair 30 does not occur easily due to the surface of the paper on which to perform the recording, and it is possible to appropriately rectify skewing by selecting the combined skew rectification mode in a situation in which abutment of the paper leading end to the transport roller pair 30 occurs easily.

Hereafter, a description will be given of a more specific example. The transport roller pair 30 according to the present example is configured to include the transport drive roller 30a which serves as the first transport roller and the transport driven roller 30b which has a relatively low friction coefficient between the transport driven roller 30b and the recording paper than the transport drive roller 30a and serves as the second transport roller.

In such a configuration, in a case in which at least one of the first surface (the obverse surface) and the second surface (the reverse surface) has a high friction coefficient between the second surface and the transport drive roller 30a relative to the other surface, since abutment of the paper leading end when contacting the transport drive roller 30a occurs easily in the surface of the paper which has the higher friction coefficient, it is conceivable to select the combined skew rectification mode.

For example, in the case of a postcard in which a communication surface is a surface which is subjected to glossy treatment in order to support ink jet recording and an address surface which is the opposite side thereof is a non-glossy treatment surface, that is, a similar surface to ordinary paper, the communication surface which is subjected to the glossy treatment has a high friction coefficient between the communication surface and the transport drive roller 30a relative to the non-glossy treatment address surface, therefore, in a case in which transporting is performed with the communication surface which is subjected to glossy treatment facing downward (that is, in a case in which printing is performed on the address surface), in comparison to the opposite case, there is a tendency for abutment of the paper leading end to the transport drive roller 30a to occur easily.

Accordingly, in such a case, the combined skew rectification mode is applied in a case in which the communication surface which is subjected to glossy treatment is transported facing downward (a case in which the printing is performed on the address surface), and only the skew rectification operation of one of the backward rotating abutting system or the take-in discharge system is executed, for example, without applying the combined skew rectification mode in a case in which the address surface which is not subjected to glossy treatment is transported facing downward (a case in which the printing is performed on the communication surface).

By adopting such a configuration, in a situation in which skewing does not occur easily due to the surface of the paper on which the recording is performed, it is possible to suppress a reduction in throughput by selecting the combined skew rectification mode, and in a situation in which skewing occurs easily, it is possible to appropriately rectify the skewing by selecting the combined skew rectification mode.

(3) In this example, in the skew rectification operation of the take-in discharge system (the second skew rectification operation), when causing the transport roller pair 30 to rotate backward to discharge the paper leading end to the upstream side of the transport roller pair 30, since the driving of the intermediate roller 20 is simply stopped, if an external force is applied, the intermediate roller 20 assumes a rotating state. However, instead, hold control may be performed on the second drive motor 153 and the rotation of the intermediate roller 20 may be controlled to be actively stopped.

Alternatively, when causing the transport roller pair 30 to rotate backward to discharge the paper leading end to the upstream side of the transport roller pair 30, it is possible to cause the intermediate roller 20 to rotate forward and to form large bending using the recording paper.

(4) In this example, in the skew rectification operation of the backward rotating abutting system (the first skew rectification operation), as the name implies, when the paper leading end abuts the transport roller pair 30, the transport roller pair 30 is caused to rotate backward; however, when the paper leading end abuts the transport roller pair 30, it is possible to stop the transport roller pair 30.

The invention is not limited to the embodiments or the modification examples described as appropriate and may be modified in various ways within the scope of the invention described in the claims, and the modifications should be construed as being included within the scope of the invention.

The entire disclosure of Japanese Patent Application No. 2016-197375, filed Oct. 5, 2016, No. 2016-230082, filed Nov. 28, 2016 and No. 2017-116125, filed Jun. 13, 2017 are expressly incorporated by reference herein.

What is claimed is:

1. A recording apparatus comprising:
a recorder which performs recording on a medium;
a transport roller pair which is provided upstream of the recorder in a transport path of the medium and transports the medium to a position facing the recorder;
a first roller which feeds the medium toward the transport roller pair;
a plurality of second rollers are provided with respect to the width of the first roller and which contact the first roller to be driven to rotate; and
an adjustment unit which adjusts an angle which is formed between a rotating shaft center line of the second rollers and a medium transport direction.

2. The recording apparatus according to claim 1,
wherein the second rollers are provided to be capable of being displaced along an axial line direction of a rotating shaft of the second rollers, and
wherein regulating portions which are on both sides of the second rollers in the axial line direction and regulate the displacement of the second rollers in the axial line direction are provided closer to the upstream side than the rotating shaft in the medium transport direction.

3. The recording apparatus according to claim 1,
wherein a plurality of driven rollers is provided along a circumferential direction of the first roller, and
wherein among the plurality of driven rollers, at least the driven roller which is positioned first on the upstream side of the transport roller pair or the driven roller which is positioned first on the upstream side thereof is the second roller.

4. The recording apparatus according to claim 1,
wherein the adjustment unit is configured to include a convex portion which is provided on the second roller on an inner circumferential portion which contacts a rotating shaft of the second roller, and
wherein the second roller oscillates using a contact portion between the convex portion and the rotating shaft as a fulcrum and an angle between the rotating shaft center line and a medium transport direction is adjusted.

5. The recording apparatus according to claim 1, further comprising:
a jump regulating portion which regulates jumping to the second roller of a medium rear end which deviates from a nipping position between the first roller and the second roller.
